(19) United States
(12) Patent Application Publication
(10) Pub. No.: US 2026/0368112 A1
(43) Pub. Date: Nov. 19, 2026

(54) ELECTRONIC DEVICE AND INFORMATION TRANSMISSION METHOD THEREOF

(71) Applicant: ASPEED Technology Inc., Hsinchu City (TW)

(72) Inventors: Po-Wei Huang, Hsinchu City (TW); Chih-Chiang Mao, Hsinchu City (TW)

(73) Assignee: ASPEED Technology Inc., Hsinchu City (TW)

(21) Appl. No.: 19/232,877

(22) Filed: Jun. 10, 2025

(30) Foreign Application Priority Data
May 15, 2025 (TW) 114118208

(51) Int. Cl. G06F 13/20

(52) U.S. Cl. CPC G06F 13/20; G06F 2213/40

(57) ABSTRACT

Provided are an electronic device and an information transmission method thereof are provided. The electronic device includes a management and control circuit and a first input/output (I/O) expander. The management and control circuit includes a first data format converter. The first I/O expander is coupled to the management and control circuit through a first interface circuit corresponding to a first transmission format, in which the first data format converter of the management and control circuit converts transmission data to the first transmission format, and transmits the transmission data to the first I/O expander through the first interface circuit. The transmission data includes command information, address information, and data information.

### CROSS-REFERENCE TO RELATED APPLICATION

This application claims the priority benefit of Taiwan application serial no. 114118208, filed on May 15, 2025. The entirety of the above-mentioned patent application is hereby incorporated by reference herein and made a part of this specification.

### BACKGROUND

### Technical Field

The disclosure relates to an electronic device and an information transmission method thereof, and particularly relates to an electronic device and an information transmission method thereof that may reduce design complexity and design cost.

### Related Art

In the related technical field, in order to provide various different types of applications, the electronic device requires the baseboard management controller to implement multiple input/output interface circuits corresponding to multiple different types of application circuits, to communicate information with multiple application circuits respectively. Since multiple application circuits may correspond to multiple different information transmission formats, in such a situation, when the application circuits connected to the electronic device change, the baseboard management controller needs to be redesigned to accommodate such changes. As a result, the design complexity and design cost of the electronic device increase significantly.

### SUMMARY

The disclosure provides an electronic device and an information transmission method thereof, which may reduce design complexity of a management and control circuit of the electronic device.

The electronic device of the disclosure includes a management and control circuit and a first input/output (I/O) expander. The management and control circuit includes a first data format converter. The first I/O expander is coupled to the management and control circuit through a first interface circuit corresponding to a first transmission format, in which the first data format converter of the management and control circuit converts transmission data to the first transmission format, and transmits the transmission data as the first transmission format to the first I/O expander through the first interface circuit. The transmission data includes command information, address information, and data information.

An operation method of the electronic device of the disclosure includes the following. A first data format converter is disposed in a management and control circuit. A first input/output (I/O) expander is coupled to the management and control circuit through a first interface circuit corresponding to a first transmission format. Transmission data is converted to the first transmission format by the first data format converter of the management and control circuit. Also, the transmission data as the first transmission format is transmitted to the first I/O expander through the first interface circuit, in which the transmission data includes command information, address information, and data information.

Based on the above, in the electronic device of the disclosure, the management and control circuit of the electronic device transmits transmission data with the command information to the I/O expander, and thereby the management and control circuit may perform control operations on multiple peripheral circuits in the electronic device. Corresponding to multiple peripheral circuits that may respectively have multiple different interfaces, the management and control circuit does not need to dispose interface circuits of multiple different formats, which may effectively reduce the design complexity of the management and control circuit and effectively improve the working efficiency thereof.

### BRIEF DESCRIPTION OF THE DRAWINGS

FIG. 1 to FIG. 4 illustrate schematic diagrams of an electronic device of multiple embodiments of the disclosure.

FIG. 5 illustrates a flowchart of an operation method of the electronic device of an embodiment of the disclosure.

### DESCRIPTION OF THE EMBODIMENTS

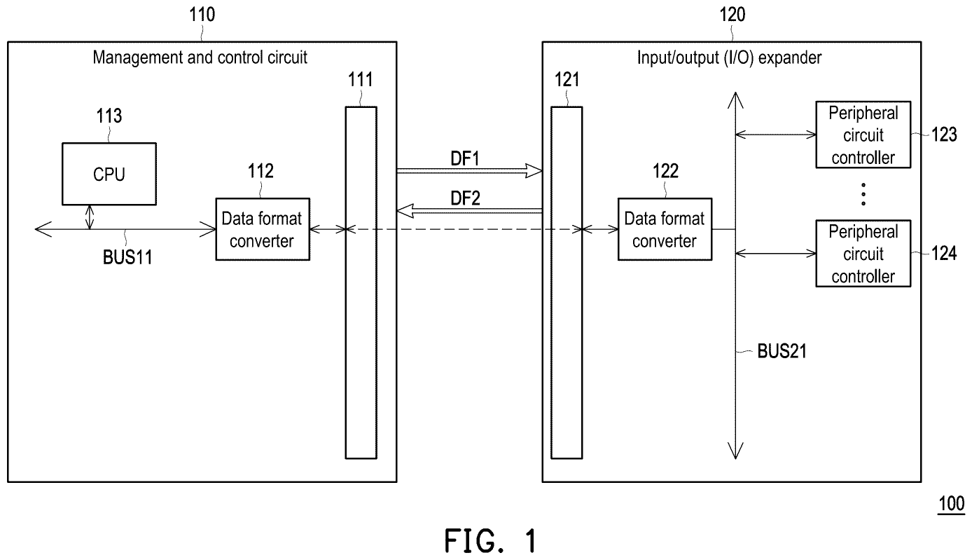

Referring to FIG. 1, FIG. 1 illustrates a schematic diagram of an electronic device of an embodiment of the disclosure. An electronic device 100 includes a management and control circuit 110 and an input/output (I/O) expander 120. The management and control circuit 110 includes an interface circuit 111, a data format converter 112, and a central processing unit (CPU) 113. The CPU 113 is coupled to the data format converter 112 through a bus BUS11. The data format converter 112 is coupled to the interface circuit 111. The I/O expander 120 includes an interface circuit 121, a data format converter 122, and multiple peripheral circuit controllers 123 to 124. In the I/O expander 120, the data format converter 122 and the multiple peripheral circuit controllers 123 to 124 may be mutually coupled through a bus BUS21, and the data format converter 122 is coupled to the interface circuit 121. Between the management and control circuit 110 and the I/O expander 120, the interface circuit 111 in the management and control circuit 110 may be mutually coupled with the interface circuit 121 in the I/O expander 120, and thereby perform the transmission operation of transmission data DF1. In this embodiment, the management and control circuit 110 may be a baseboard management controller (BMC) circuit. The interface circuits 111, 121 may both be low voltage differential signal (LVDS) tunneling protocol & interface (LTPI) circuits, and are configured to transmit the transmission data DF1 as low voltage differential signals.

In this embodiment, the transmission data DF1 may be transmitted in the form of data frames. In each data frame of the transmission data DF1, command information, address information, and data information may be included. It should be noted that, the command data may include read command, write command, read data command, and data write full command. In implementation details, the management and control circuit 110 may perform the transmission operation of command information through two set bits in the transmission data DF1. For example, the truth table may be as follows.

| Binary value | Command information |
|---|---|
| 00 | Read command |
| 01 | Read data command |
| 10 | Write command |
| 11 | Data write full command |

In which, the read command is for the management and control circuit 110 to indicate to read any data from the I/O expander 120, and the read data command indicates that the I/O expander 120 should return the read data to the management and control circuit 110. The data write full command is configured to indicate that the data write operation that the management and control circuit 110 performs on the I/O expander 120 is completed. The I/O expander 120 may transmit the data write full command to the management and control circuit 110, in which the data write full command may serve as a notification signal for the completion of data writing. In the embodiment of the disclosure, the write operation of the management and control circuit 110 corresponds to the data storage depth of the data buffer of the I/O expander 120, so as to perform a certain quantity of data write operations, and fill the data buffer of the I/O expander 120.

Regarding the operational details of this embodiment, the CPU 113 in the management and control circuit 110 may transmit data through the bus BUS11. The CPU 113 may transmit the data to be sent to the data format converter 112 through the bus BUS11. The data transmitted by the CPU 113 may be, for example, in advanced high-performance bus (AHB) signal format or advanced extensible interface (AXI) signal format.

The data format converter 112 is configured to perform the transmission format conversion operation of the transmission data, and convert the transmission data from AHB signal format or AXI signal format to low voltage differential signal format. Then, the data format converter 112 may transmit the transmission data converted to low voltage differential signal format to the interface circuit 111, and the interface circuit 111 makes the transmission data in low voltage differential signal format as the transmission data DF1, and transmits the transmission data DF1 to the interface circuit 121 of the I/O expander 120.

After the I/O expander 120 receives the transmission data DF1 through the interface circuit 121, the transmission data DF1 may be transmitted to the data format converter 122. The data format converter 122 may convert the received transmission data DF1 from low voltage differential signal format to a transmission format suitable for the peripheral circuit controllers 123 to 124 (for example, AHB signal format or AXI signal format) to obtain the received data, and transmit the received data to the corresponding peripheral circuit controllers 123 to 124 through the bus BUS21.

On the other hand, when the I/O expander 120 needs to transmit data to the management and control circuit 110, any one of the peripheral circuit controllers 123 to 124 of the I/O expander 120 may transmit data to the data format converter 122 through the bus BUS21. The data format converter 122 may convert the data to low voltage differential signal format, and obtain transmission data DF2 by packaging the data in the form of data frames. The interface circuit 121 of the I/O expander 120 is configured to transmit the transmission data DF2 to the interface circuit 111 of the management and control circuit 110.

Furthermore, the data format converter 112 of the management and control circuit 110 is configured to convert the received data (transmission data DF2) received by the interface circuit 111 to AHB signal format or AXI signal format, and transmit the received data after format conversion to the CPU 113 through the bus BUS11.

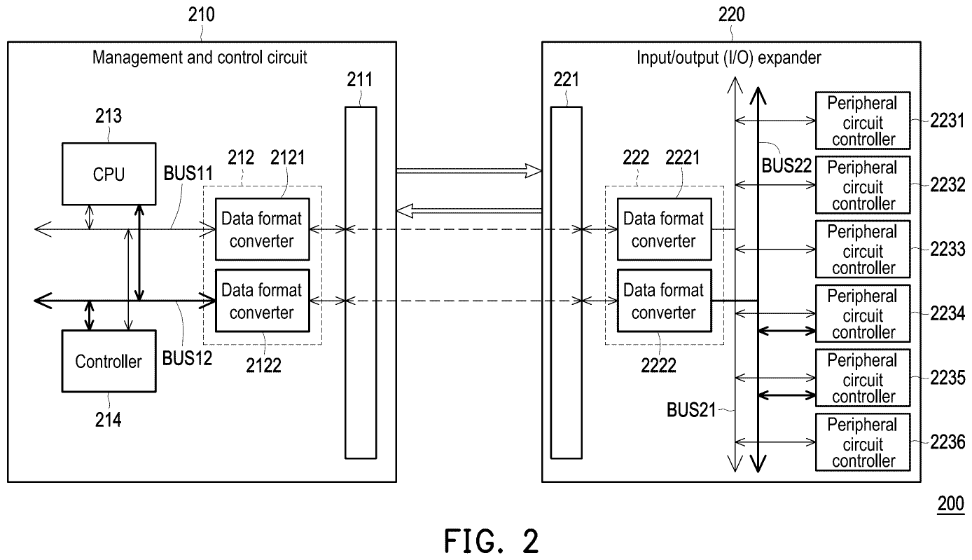

Please refer to FIG. 2, FIG. 2 illustrates a schematic diagram of the electronic device of another embodiment of the disclosure. An electronic device 200 includes a management and control circuit 210 and an I/O expander 220. The management and control circuit 210 includes an interface circuit 211, a data format convert circuit 212, a CPU 213, and a controller 214. The I/O expander 220 includes an interface circuit 221, a data format convert circuit 222, and peripheral circuit controllers 2231 to 2236. Different from the foregoing embodiment, the management and control circuit 210 of this embodiment has buses BUS11, BUS12, in which the CPU 213 is coupled to the data format convert circuit 212 through the bus BUS11. The controller 214 is coupled to the data format convert circuit 212 through the other bus BUS12. The data format convert circuit 212 includes data format converters 2121 and 2122. The data format converter 2121 is coupled to the CPU 213 through the bus BUS11; the data format converter 2122 is coupled to the controller 214 through the bus BUS12. In this embodiment, the controller 214 may be a memory controller.

It should be noted that the CPU 213 and the controller 214 may perform data transmission and reception operations through different transmission formats, in which the CPU 213 is configured, for example, to transmit and receive transmission data in AHB signal format or AXI format; the controller 214 may be configured to transmit and receive transmission data in meter bus (M-BUS) signal format.

Correspondingly, the data format converter 2121 is configured to convert transmission data between low voltage differential signal format and AHB signal format, or, the data format converter 2121 is configured to convert transmission data between low voltage differential signal format and AXI format. The data format converter 2122 is configured to convert transmission data between low voltage differential signal format and M-BUS signal format.

In the I/O expander 220, there may be multiple buses BUS21, BUS22. The data format convert circuit 222 includes data format converters 2221 and 2222. The data format converter 2221 is coupled to the peripheral circuit controllers 2231 to 2236 through the bus BUS21; the data format converter 2222 is coupled to the peripheral circuit controllers 2234 and 2235 through the bus BUS22. The buses BUS21, BUS22 are configured to transmit data in different transmission formats, for example, the bus BUS21 is configured to transmit data in AHB signal format or AXI format; the bus BUS22 is configured to transmit data in low voltage differential signal format. The data format converter 2221 is configured to convert transmission data between low voltage differential signal format and AHB signal format, or, the data format converter 2221 is configured to convert transmission data between low voltage differential signal format and AXI format. The data format converter 2222 is configured to convert transmission data between low voltage differential signal format and M-BUS signal format.

It should be noted that in this embodiment, the peripheral circuit controllers 2234 and 2235 may perform transmission and reception operations of transmission data through two transmission formats. The peripheral circuit controllers 2231 to 2233 and 2236 may perform transmission and reception operations of transmission data through AHB signal format, or AXI format.

In addition, regarding the details of the transmission operation of transmission data between the management and control circuit 210 and the I/O expander 220, the CPU 213 of the management and control circuit 210 may, through the data format converter 2121 and the interface circuit 211, work with the interface circuit 221 and the data format converter 2221 in the I/O expander 220 to communicate with any one of the peripheral circuit controllers 2231 to 2233 and 2236. The related details are explained in detail in the embodiment of FIG. 1, and will not be repeated here.

In addition, the controller 214 of the management and control circuit 210 may, through the data format converter 2122 and the interface circuit 211, work with the interface circuit 221 and the data format converter 2222 in the I/O expander 220 to communicate with any one of the peripheral circuit controllers 2234 and 2235. The detailed operation is similar to that explained in the embodiment of FIG. 1, with the difference only in the transmission format conversion operation. The differences should be understandable to persons skilled in the art, and will not be repeated here.

Incidentally, in this embodiment, the peripheral circuit controllers 2231 to 2236 respectively correspond to multiple peripheral circuits such as analog-to-digital conversion circuit, pulse width modulation signal generation circuit, rotation speed detection circuit, improved integrated circuit bus (I³C), integrated circuit bus (I²C), joint test action group (JTAG) signal generation circuit.

Certainly, the types and quantity of the peripheral circuits mentioned above are merely examples for illustration and should not be used to limit the scope of implementation of the disclosure. Persons skilled in the art may dispose the required peripheral circuits according to actual needs, and correspondingly adjust the quantity of peripheral circuit controllers, without any specific limitations.

It should be noted that in this embodiment, the data format converters 2121, 2122, 2221, 2222 may be digital circuits, and may be implemented using hardware architectures of data format converters well-known to persons skilled in the art, without any specific limitations.

In this embodiment, the management and control circuit 210 may, through the I/O expander 220, effectively communicate with peripheral circuits having multiple different signal formats through the data format converters 2121, 2122, 2221, 2222. This configuration effectively reduces the design complexity of the management and control circuit 210 and effectively improves the working efficiency of the electronic device 200.

Incidentally, in this embodiment, designers may increase the quantity of buses in the management and control circuit 210 and the I/O expander 220, as well as the quantity of data format converters therein, according to actual application conditions. The illustration in FIG. 2 is merely an example for explanation and should not be configured to limit the implementation scope of the disclosure.

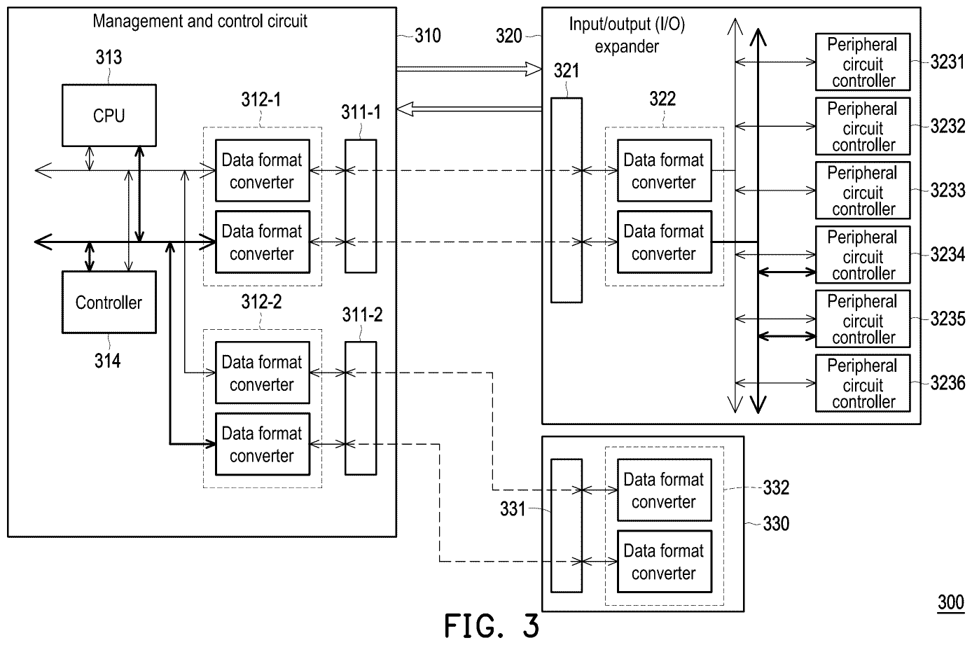

Please refer to FIG. 3, FIG. 3 illustrates a schematic diagram of the electronic device of another embodiment of the disclosure. An electronic device 300 includes a management and control circuit 310 and I/O expanders 320, 330. The management and control circuit 310 includes interface circuits 311-1, 311-2, data format convert circuits 312-1, 312-2, a central processing unit (CPU) 313, and a controller 314. The I/O expander 320 includes an interface circuit 321, a data format convert circuit 322, and peripheral circuit controllers 3231 to 3236. The I/O expander 330 includes an interface circuit 331 and a data format convert circuit 332.

In this embodiment, the management and control circuit 310 is coupled to the interface circuit 321 of the I/O expander 320 through the interface circuit 311-1; the management and control circuit 310 is coupled to the interface circuit 331 of the I/O expander 330 through the interface circuit 311-2. Between the management and control circuit 310 and the I/O expander 320, the data format convert circuits 312-1, 322 may be configured to convert the transmission format of the transmission data, thereby completing the data communication actions between the CPU 313, the controller 314, and the peripheral circuit controllers 3231 to 3236. Between the management and control circuit 310 and the I/O expander 330, the data format convert circuits 312-2, 332 may be configured to convert the transmission format of the transmission data, thereby achieving the data transmission and reception actions therebetween.

In this embodiment, the management and control circuit 310 is coupled to the I/O expanders 320, 330 through the concept of parallel connection. By increasing the quantity of interface circuits and corresponding data format convert circuits in the management and control circuit 310, the quantity of I/O expanders that can be coupled to the management and control circuit 310 may be correspondingly increased. In other embodiments of the disclosure, the quantity of I/O expanders in the electronic device may be greater than 2, without any specific limitations.

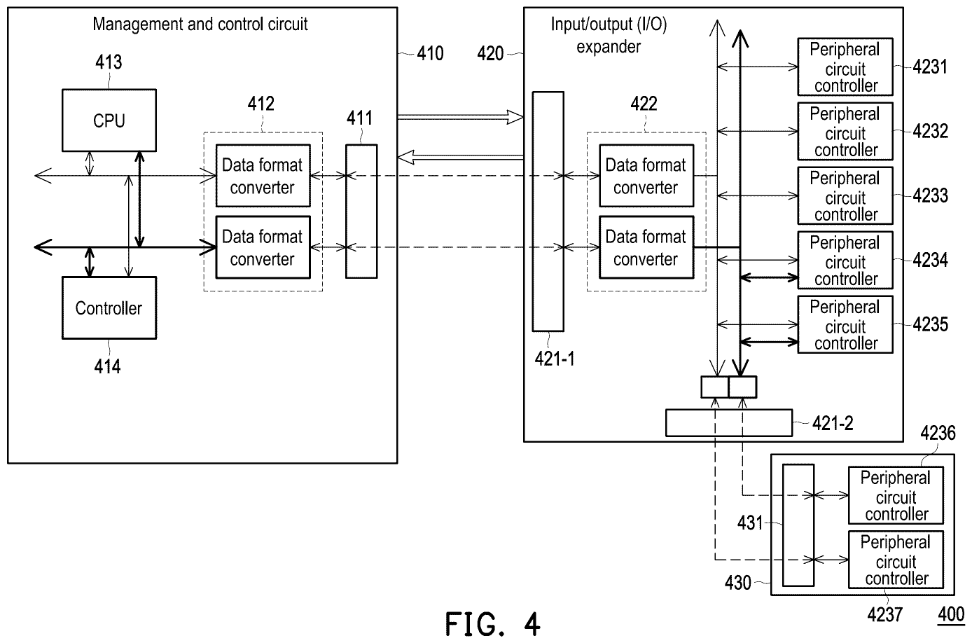

Please refer to FIG. 4, FIG. 4 illustrates a schematic diagram of the electronic device of another embodiment of the disclosure. An electronic device 400 includes a management and control circuit 410 and I/O expanders 420, 430. The management and control circuit 410 includes an interface circuit 411, a data format convert circuit 412, a CPU 413, and a controller 414. The I/O expander 420 includes interface circuits 421-1, 421-2, a data format convert circuit 422, and peripheral circuit controllers 4231 to 4235. The I/O expander 430 includes an interface circuit 431 and peripheral circuit controllers 4236, 4237.

In detail, the coupling relationship between the management and control circuit 410 and the I/O expander 420 is similar to the embodiment of FIG. 2 mentioned above, so details will not be repeated here. In this embodiment, the I/O expander 420 has an additional interface circuit 421-2. The I/O expander 420 is coupled to the interface circuit 431 of the I/O expander 430 through the interface circuit 421-2.

It should be noted that in this embodiment, the corresponding data format convert circuit may not be disposed in the I/O expander 430, and some of the peripheral circuit controllers 4236, 4237 in the electronic device 400 may be transferred and disposed on the I/O expander 430. Based on the interface circuit 421-1 being located downstream of the data format convert circuit 422, the interface circuit 421-1 may directly transmit the transmission data in AHB signal format or AXI format corresponding to the peripheral circuit controllers 4236, 4237, as well as M-BUS signal format, saving the circuit cost and area of the corresponding data format convert circuit.

In this embodiment, the management and control circuit 410 is coupled to the I/O expanders 420, 430 through the concept of series connection. In other embodiments of the disclosure, the I/O expander 430 may additionally dispose an interface circuit to connect to the next level of I/O expander in series. The I/O expander 420 may further dispose another interface circuit to connect to another I/O expander. Here, persons skilled in the art may combine the concepts of parallel connection and series connection based on the embodiments of FIG. 3 and FIG. 4 to arbitrarily expand the quantity of I/O expanders. That is to say, the connection form between the management and control circuit and multiple I/O expanders is not limited to what is shown in FIG. 3 and FIG. 4. The illustrations in FIG. 3 and FIG. 4 are merely examples for illustration and should not be used to limit the scope of implementation of the disclosure.

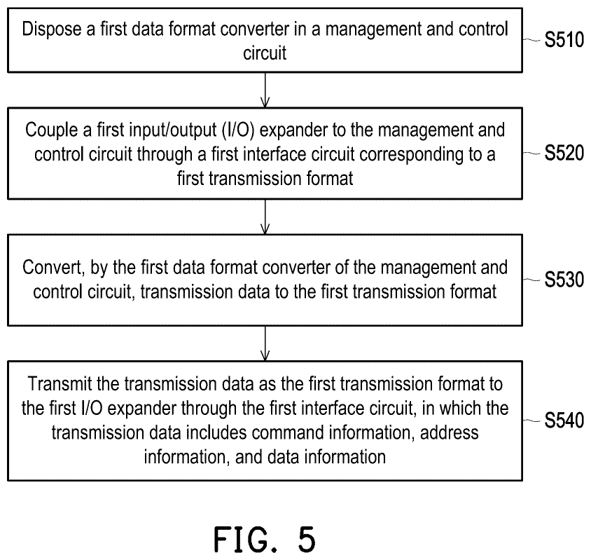

Please refer to FIG. 5, FIG. 5 illustrates a flowchart of an information transmission method of an electronic device according to an embodiment of the disclosure. In Step S510, a first data format converter is disposed in a management and control circuit. In Step S520, a first input/output (I/O) expander is coupled to the management and control circuit through a first interface circuit corresponding to a first transmission format. In Step S530, transmission data is converted to the first transmission format by the first data format converter of the management and control circuit. In Step S540, the transmission data as the first transmission format is transmitted to the first I/O expander through the first interface circuit, in which the transmission data includes command information, address information, and data information.

Regarding the implementation details of the foregoing steps, detailed explanations have been provided in the aforementioned multiple embodiments, so details will not be repeated here.

In summary, in the electronic device of the disclosure, the management and control circuit may perform transmission and reception of transmission data with peripheral circuit controllers through the I/O expander, in which the management and control circuit may transmit transmission data with command information to the I/O expander, and thereby perform control operations on the peripheral circuit controllers.

What is claimed is:

1. An electronic device, comprising:
a management and control circuit comprising a first data format converter; and
a first input/output (I/O) expander coupled to the management and control circuit through a first interface circuit corresponding to a first transmission format,
wherein the first data format converter of the management and control circuit converts transmission data to the first transmission format and transmits the transmission data as the first transmission format to the first I/O expander through the first interface circuit, and the transmission data comprises command information, address information, and data information.

2. The electronic device as claimed in claim 1, wherein the command information comprises read command, write command, read data command, and data write full command.

3. The electronic device as claimed in claim 1, wherein the first I/O expander further comprises a second interface circuit, and the management and control circuit performs transmission operation of data between the first interface circuit and the second interface circuit of the first I/O expander.

4. The electronic device as claimed in claim 3, wherein between the first interface circuit and the second interface circuit, the transmission data as low voltage differential signal format is transmitted.

5. The electronic device as claimed in claim 3, wherein the first data format converter is coupled to the first interface circuit and configured to perform format conversion operation of the transmission data.

6. The electronic device as claimed in claim 5, wherein the first data format convert circuit is configured to convert transmission data to low voltage differential signal format, and convert received data to advanced high-performance bus signal format, meter bus signal format, or advanced extensible interface format.

7. The electronic device as claimed in claim 3, wherein the first I/O expander comprises:
a second data format converter coupled to the second interface circuit, configured to perform format conversion operation of the transmission data.

8. The electronic device as claimed in claim 7, wherein the second data format converter is configured to convert transmission data to low voltage differential signal format, and convert received data to advanced high-performance bus signal format, meter bus signal format, or advanced extensible interface format.

9. The electronic device as claimed in claim 7, wherein the first I/O expander further comprises:
a plurality of peripheral circuit controllers coupled to the second data format converter to perform data transmission operation with the management and control circuit through the second data format converter, the second interface circuit, and the first interface circuit.

10. The electronic device as claimed in claim 3, wherein the first I/O expander further comprises a third interface circuit, the electronic device further comprises a second I/O expander, and the first I/O expander is coupled to a fourth interface circuit of the second I/O expander through the third interface circuit.

11. The electronic device as claimed in claim 3, wherein the management and control circuit further comprises a third interface circuit, the electronic device further comprises a second I/O expander, the management and control circuit is coupled to a fourth interface circuit of the second I/O expander through the third interface circuit.

12. An information transmission method of an electronic device, comprising:
disposing a first data format converter in a management and control circuit;
coupling a first input/output (I/O) expander to the management and control circuit through a first interface circuit corresponding to a first transmission format;
converting, by the first data format converter of the management and control circuit, transmission data to the first transmission format; and
transmitting the transmission data as the first transmission format to the first I/O expander through the first interface circuit, wherein the transmission data comprises command information, address information, and data information.

13. The information transmission method as claimed in claim 12, wherein the command information comprises read command, write command, read data command, and data write full command.

14. The information transmission method as claimed in claim 12, further comprising:
performing, by the management and control circuit, transmission operation of data between the first interface circuit and a second interface circuit of the first I/O expander, wherein between the first interface circuit and the second interface circuit, the transmission data as low voltage differential signal format is transmitted.

15. The information transmission method as claimed in claim 12, further comprising:
converting, by the first data format converter, transmission data to low voltage differential signal format, and converting received data to advanced high-performance bus signal format, meter bus signal format, or advanced extensible interface format.

16. The information transmission method as claimed in claim 12, further comprising:
converting, by a second data format converter of the first I/O expander, transmission data to low voltage differential signal format, and converting received data to advanced high-performance bus signal format, meter bus signal format, or advanced extensible interface format.

17. The information transmission method as claimed in claim 14, further comprising:
coupling the first I/O expander to a fourth interface circuit of a second I/O expander through a third interface circuit.

18. The information transmission method as claimed in claim 14, further comprising:
coupling the management and control circuit to a fourth interface circuit of a second I/O expander through a third interface circuit.
